(19) United States
(12) Patent Application Publication
(10) Pub. No.: US 2021/0374751 A1
(43) Pub. Date: Dec. 2, 2021

(54) METHOD AND SYSTEM FOR FACILITATING PAYMENT TRANSACTIONS

(71) Applicant: MASTERCARD INTERNATIONAL INCORPORATED, Purchase, NY (US)

(72) Inventors: Jitendra Singh WADHWA, Pune (IN); Ketan GODKHINDI, Pune (IN); Surbhi MALHOTRA, Pune (IN); Rajesh Pralhadrao MAHALLE, Pune (IN)

(21) Appl. No.: 17/326,851

(22) Filed: May 21, 2021

(30) Foreign Application Priority Data
May 29, 2020 (IN) 202021022662

(51) Int. Cl. G06Q 20/40; G06Q 20/34

(52) U.S. Cl. CPC G06Q 20/4014; G06Q 20/347; G06Q 20/4093

(57) ABSTRACT

A method for facilitating payment transactions includes receiving a transaction request for a payment transaction initiated at a payment terminal device using a transaction card of a user. A predefined category of the user is identified based on the transaction request and a service application is remotely activated in a first operation mode on a user device of the user such that the first operation mode is associated with the identified predefined category. Payment transaction messages associated with the payment transaction are communicated to the activated service application, which translates the payment transaction messages to a predefined message format. In response to the payment transaction messages, first authentication information is received from the activated service application such that the first authentication information is entered by the user in the predefined message format. The payment transaction is processed based on successful authentication of the user.

### CROSS-REFERENCE TO RELATED APPLICATION(S)

This application claims priority to Indian Patent Application No. 202021022662, filed May 29, 2020, entitled “Method and System for Facilitating Payment Transactions”, the entirety of which is incorporated herein by reference.

### BACKGROUND

### Field of the Disclosure

Various embodiments of the present disclosure relate generally to payment transaction systems. More particularly, various embodiments of the present disclosure relate to facilitation of payment transactions.

### Description of the Related Art

In past few decades, technological advancements have led to the development of payment transaction systems that allow users to perform cashless payment transactions, such as deposits and withdrawals, credit transfers, purchase payments, or the like. Such systems enable cashless payment transactions by way of various types of transaction cards, such as credit cards, debit cards, pre-paid cards, or the like. Typically, a cashless payment transaction is performed by using a transaction card at a payment terminal device, such as an Automated Teller Machine (ATM) or a Point-of-Sale (POS) device. While using the transaction card at the ATM or the POS device, a cardholder of the transaction card is often prompted to provide authentication information, e.g., a personal identification number (PIN), a password, or a one-time password (OTP), for authentication. The payment transaction may be approved or declined based on validation of the authentication information provided by the cardholder.

All transaction related messages (e.g., transaction approval message, transaction amount message, OTP message, or the like) are either communicated to the payment terminal device or a registered user-device of the cardholder for presenting to the cardholder. Generally, screen display is the primary means of communication used by the payment terminal devices or the user device for presenting the transaction related messages to the cardholder. However, such screen displays are of no use to cardholders who are differently abled, for example, visually impaired. As a solution for visually-impaired cardholders, the payment terminal devices these days are enhanced to have audio capabilities for presenting the transaction messages. However, such audio capabilities are not a viable solution for deaf-blind cardholders. Further, such differently-abled cardholders become easy targets to transaction frauds. Hence, the present payment transaction systems have failed to provide a one-stop secure transaction solution for all differently-abled users, such as deaf-blind users, blind-mute users, or the like.

In light of the foregoing, there is a need for a technical solution that solves the abovementioned problems and facilitates secure and seamless payment transactions for differently-abled users.

### SUMMARY

In an embodiment of the present disclosure, a method for facilitating payment transactions is provided. The method includes reception of a transaction request by a server to process a payment transaction initiated at a payment terminal device using a transaction card of a user. Based on the transaction request, a first predefined category of the user is identified by the server. A service application is activated on a user device of the user by the server. The service application is remotely activated in a first operation mode associated with the first predefined category of the user. One or more payment transaction messages associated with the payment transaction are communicated by the server, to the service application activated on the user device. The service application activated in the first operation mode translates the one or more payment transaction messages to a predefined message format. In response to the communicated one or more payment transaction messages, first authentication information for authenticating the user is received by the server from the service application activated on the user device. The first authentication information is entered by the user in the predefined message format by way of the service application activated in the first operation mode. The initiated payment transaction is processed based on successful authentication of the user. The user is authenticated based on the first authentication information.

In another embodiment of the present disclosure, a system for facilitating payment transactions is provided. The system includes a server that is configured to receive a transaction request to process a payment transaction initiated at a payment terminal device using a transaction card of a user. The server is configured to identify a first predefined category of the user based on the transaction request and activate a service application on a user device of the user. The service application is remotely activated in a first operation mode associated with the first predefined category of the user. The server is further configured to communicate one or more payment transaction messages associated with the payment transaction, to the service application activated on the user device. The service application activated in the first operation mode translates the one or more payment transaction messages to a predefined message format. In response to the communicated one or more payment transaction messages, the server is further configured to receive, from the service application activated on the user device, first authentication information for authenticating the user. The first authentication information is entered by the user in the predefined message format by way of the service application activated in the first operation mode. The server is further configured to process the initiated payment transaction based on successful authentication of the user. The user is authenticated based on the first authentication information.

### BRIEF DESCRIPTION OF DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates an exemplary environment for facilitating payment transactions, in accordance with an exemplary embodiment of the present disclosure;

FIGS. 2A and 2B are schematic diagrams that illustrate front and back views of an exemplary transaction card of FIG. 1, in accordance with an exemplary embodiment of the present disclosure;

FIG. 3 is a process flow diagram that illustrates issuance of the transaction card to a user, in accordance with an exemplary embodiment of the present disclosure;

FIGS. 4A, 4B, and 4C, collectively represent a process flow diagram that illustrates facilitation of a payment transaction by an issuer server of FIG. 1, in accordance with an exemplary embodiment of the present disclosure;

FIG. 5 is a schematic diagram that illustrates an exemplary scenario for facilitating a payment transaction conducted by a user at a payment terminal device of FIG. 1 using the transaction card, in accordance with an exemplary embodiment of the present disclosure;

FIG. 6 is a schematic diagram that illustrates translation of a textual transaction message to different vibrating patterns in Morse code format, in accordance with an exemplary embodiment of the present disclosure;

FIG. 7 is a block diagram that illustrates an issuer server of FIG. 1, in accordance with an exemplary embodiment of the present disclosure;

FIG. 8 is a block diagram that illustrates a user device of FIG. 1, in accordance with an exemplary embodiment of the present disclosure;

FIG. 9 is a block diagram that illustrates a system architecture of a computer system, in accordance with an exemplary embodiment of the present disclosure;

FIG. 10 is a flowchart that illustrates a method for issuing the transaction card to a user, in accordance with an exemplary embodiment of the present disclosure;

FIGS. 11A and 11B, collectively represent a flowchart that illustrates a method for facilitating a payment transaction, in accordance with an exemplary embodiment of the present disclosure; and

FIG. 12 is a high-level flow chart that illustrates a method for facilitating a payment transaction, in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION OF EMBODIMENTS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Generally, screen display is the primary means of communication used by payment terminal devices, such as Automated Teller Machines (ATMs) or a Point-of-Sale (POS) devices, to present transaction related messages to users. Thus, present payment transaction systems are not user friendly or convenient for differently-abled users, such as deaf-blind users, blind-mute users, or the like. Further, such differently-abled users become easy targets to transaction frauds.

Various embodiments of the present disclosure provide a method and a system that solve the abovementioned problems by facilitating secure card-based payment transactions for differently-abled users. The system includes a server (e.g., an issuer server or a payment network server) that assigns (or reserves) one or more unique identification numbers (for example, Bank Identification Numbers) to each of a plurality of predefined categories, for example, a plurality of differently-abled categories. Thus, when a user, who is differently-abled and belongs to a first differently-abled category, requests for a transaction card, the transaction card that has a first identification number assigned to the first differently-abled category is issued to the user. Upon issuance of the transaction card, a service application, hosted by the server, is installed on a user device of the user. Using the service application running on the user device, the user is allowed to set reference authentication information (e.g., personal identification number), in a predefined message format (e.g., Morse code format), for the transaction card. For example, the user may utilize a touch-sensitive display screen of the user device for Morse code inputs. The service application translates the reference authentication information that is in Morse code format to a server compatible message format and communicates the translated reference authentication information to the server. Upon receiving the reference authentication information, the server links the reference authentication information to the transaction card of the user for authentication purpose.

The transaction card may be utilized at a payment terminal device (e.g., an ATM or a POS device) by the user for initiating a payment transaction. The payment terminal device communicates a transaction request, including details of the payment transaction, to the server. The details may include the first identification number of the transaction card. Upon receiving the transaction request, the server determines whether the first identification number is reserved for a predefined category, i.e., a differently-abled category. When the server determines that the first identification number is reserved for a differently-abled category, the server identifies the differently-abled category to which the first identification number is assigned, here, the first differently-abled category. The server then communicates a time-out extension message to the payment terminal device to extend a time-out period for the payment transaction and remotely activates the service application on the user device in a first operation mode, which is associated with the identified first differently-abled category. The server further communicates to the user device, a payment transaction message to notify the user regarding the initiation of the payment transaction. The user device receives the payment transaction message, and the activated service application causes the user device to translate the payment transaction message to Morse code format and present to the user as one of a vibrotactile output, an audio output, or a visual output. By way of Morse code interactions, the service application further prompts the user to provide the authentication information of the transaction card. Based on the prompting, the user enters first authentication information, in Morse code format, using the activated service application. The service application causes the user device to translate the first authentication information from the Morse code format to server compatible message format and the user device communicates the translated first authentication information to the server. The server validates the first authentication information based on the reference authentication information linked to the transaction card. Upon successful validation of the first authentication information, the user is successfully authenticated. The server then processes the payment transaction and communicates a transaction response to the payment terminal device and the user device. The activated service application on the user device again causes the user device to translate the transaction response to Morse code format and present to the user as one of a vibrotactile output, an audio output, or a visual output.

Thus, the present disclosure eliminates the need for a differently-abled user to rely on a payment terminal device for inputting authentication information and receiving transaction related messages. Hence, the present disclosure provides a convenient and seamless solution to facilitate payment transactions for differently-abled users.

### Terms Description (in Addition to Plain and Dictionary Meaning)

Payment transaction is an exchange of funds between two or more parties. For example, the payment transaction may include transferring a transaction amount from a user account to a merchant account, when a user makes a purchase from a merchant. In another example, the payment transaction may include dispensing cash, by an ATM, equivalent to a transaction amount debited from the user account based on a request from the user. The payment transaction is performed at one of a payment terminal device or a user device. Furthermore, the payment transaction also includes an inquiry, or any other operation that is performed by using a transaction card at any one of the payment terminal device or the user device.

Payment terminal device is an electronic device that enables a cardholder of a transaction card to perform a payment transaction. Examples of the payment terminal device include an ATM, a POS device, a mobile POS (MPOS) device, a Point-of-Interaction (POI) device, a Point-of-Purchase (POP) device, a bunch note acceptor, a currency recycler, or the like. The payment terminal device is enabled with near field communication (NFC) capability for facilitating contactless payment transactions. The payment terminal device is associated with a server that is configured to process the payment transaction.

Time-out period refers to a time period after which a payment terminal device automatically declines a payment transaction if no response is received from an issuer, an acquirer, or a payment network. In one example, the time-out period may be 120 seconds. Thus, the payment terminal device times out and declines a payment transaction if no response is received from the issuer, the acquirer, or the payment network within 120 seconds of initiating the payment transaction at the payment terminal device.

Time-out extension message refers to a message communicated to a payment terminal device by an issuer, an acquirer, or a payment network to extend time-out period for a payment transaction. The time-out extension message is indicative of a time duration for extending the time-out period. For example, before extension, the time-out period may be 120 seconds. When the payment terminal device receives, for a payment transaction, the time-out extension message indicating 350 seconds, the payment terminal device extends the time-out period for the payment transaction to 350 seconds. After extension, the time-out period becomes 350 seconds. Thus, the payment terminal device times out and declines the payment transaction if no response is received from the issuer, an acquirer, or a payment network within 350 seconds of initiating the payment transaction.

Transaction card is a payment device, such as a debit card, a credit card, a prepaid card, a promotional card, a contactless card, and/or any other device, that allows a cardholder to perform electronic payment transactions, such as deposits and withdrawals, credit transfers, purchase payments, and the like. The transaction card includes a transaction card memory that stores transaction card details such as transaction card number, an expiry date, a card verification value, an identification number, or the like. Further, the transaction card details are not printed or embossed on an exterior surface of the transaction card. The transaction card is issued to a cardholder by an issuer.

User device is an electronic communication device that enables a user to conduct Morse code interactions required for processing a payment transaction initiated at a payment terminal device. For example, the user device is utilized by the user to input authentication information linked to the transaction card, in Morse code format, for authentication purpose. Further, the user device receives various transaction related messages and presents to the user in Morse code format. Examples of the user device include a mobile phone, a computer, a laptop, a smartphone, a tablet, a phablet, and/or the like.

Plurality of predefined categories include various user categories defined by an issuer or a payment network. Primarily, the plurality of predefined categories include a plurality of differently-abled categories defined by the issuer or the payment network server for transaction card issuance. Examples of the plurality of differently-abled categories include a deaf-blind category, a mute-blind category, a deaf-mute category, or the like.

Service application is an application program that runs on a user device of a user. The service application is capable of operating in a plurality of operation modes such that each operation mode is designed to suit a specific category of users, for example, a specific differently-abled category. For example, a vibration mode of the service application is compatible with deaf-blind category or mute-blind category, an audio mode is compatible with the mute-blind category, and a visual mode is compatible with deaf-mute category. Based on the operation mode the service application is running in on the user device, an output mechanism of the user device is selected for presenting transaction related messages in Morse code format to the user. In one example, when the service application is running in the vibration mode, a vibration mechanism of the user device is selected. The vibration mechanism generates a vibrotactile output for presenting the transaction related message, in Morse code format. The vibrotactile output is perceived by the user through a sense of touch. In another example, when the service application is running in the audio mode, an audio generator (e.g., a speaker) of the user device is selected. The audio generator generates an audio output for presenting the transaction related message, in Morse code format. The audio output is perceived by the user through a sense of hearing. In another example, when the service application is running in the visual mode, a display of the user device is selected. The display generates a visual output for presenting the transaction related message, in Morse code format. The visual output is perceived by the user through a sense of vision.

Cardholder of a transaction card is an owner of the transaction card who is authorized to use the transaction card at one of a payment terminal device or a user device for initiating payment transactions.

Reference authentication information refers to authentication information defined by a cardholder of a transaction card for authentication purposes. Examples of the reference authentication information may include a personal identification number (PIN), a password, or the like. In one example, a payment transaction initiated using the transaction card is declined when there is a mismatch between authentication information provided by a user and the reference authentication information linked to the transaction card.

Predefined message format refers to a special message format that is recognizable by users who belong to predefined categories, such as various differently-abled categories. In one example, the predefined message format is Morse code format.

First message format refers to a message format that is associated and compatible with a server. For example, the first message format is text format.

A server is a physical or cloud data processing system on which a server program runs. The server may be implemented as hardware or software, or a combination thereof. The server may correspond to one of a payment network server, an issuer server, or an acquirer server. The server executes various programs required for processing a payment transaction.

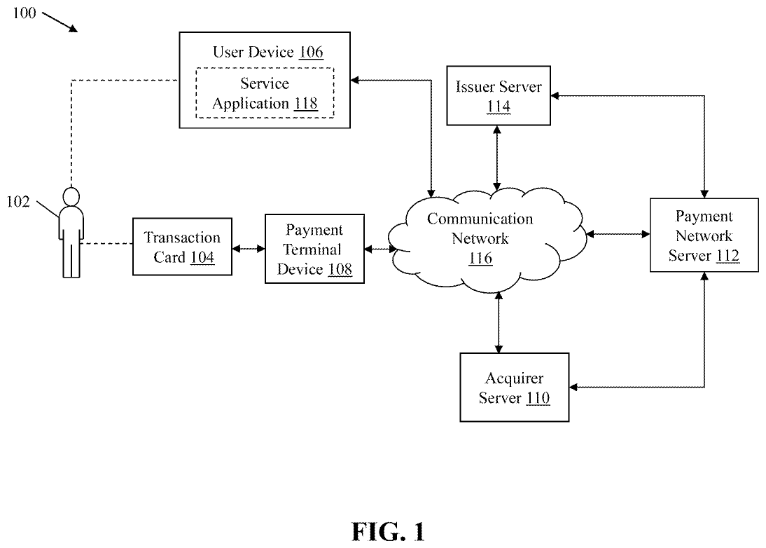

FIG. 1 is a block diagram that illustrates an exemplary environment 100 for facilitating payment transactions, in accordance with an exemplary embodiment of the present disclosure. The environment 100 includes a user 102, a transaction card 104, a user device 106, a payment terminal device 108, an acquirer server 110, a payment network server 112, and an issuer server 114. The user device 106, the payment terminal device 108, the acquirer server 110, the payment network server 112, and the issuer server 114 may communicate with each other by way of a communication network 116 or through separate communication networks established therebetween.

The user 102 is an account holder of a first payment account maintained at a financial institution, such as an issuer. In various examples, the user 102 may be deaf and blind, mute and blind, or deaf and mute. The user 102 owns the transaction card 104 that is linked to the first payment account. The user 102 may utilize the transaction card 104 at the payment terminal device 108 for performing payment transactions from the first payment account. Examples of the first payment account may include a savings account, a current account, a debit account, a credit account, a digital wallet account, or the like.

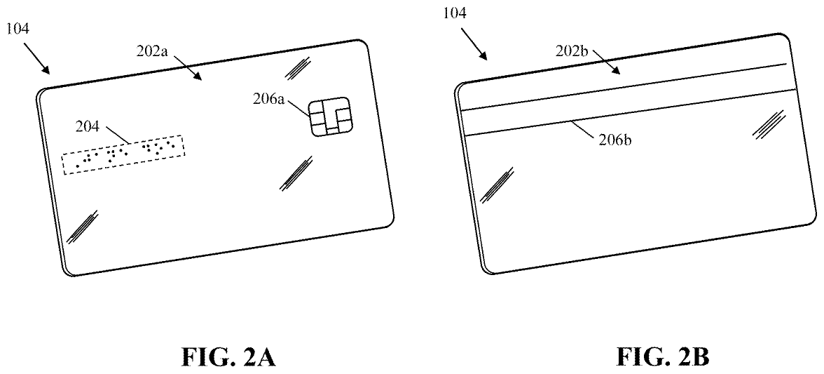

The transaction card 104 is a physical payment card associated with the first payment account of the user 102. The transaction card 104 includes suitable logic, circuitry, interface, and/or code, executable by the circuitry, for initiating payment transactions at the payment terminal device 108. The transaction card 104 stores transaction card details in a memory element therein. The transaction card details may include a transaction card number, an expiry date, a card verification value, a name of the cardholder, a first identification number, or the like. In one embodiment, the first identification number may be a Bank Identification Number (BIN) that is a part of the transaction card number. The first identification number may be indicative of a predefined category (for example, a differently-abled category) to which the cardholder belongs. The transaction card 104 may have a plastic or metallic body and may not have the corresponding details printed or embossed thereon. In one embodiment, only a name of the user 102 is printed or embossed on the transaction card 104 for the user 102 to identify the transaction card 104. For example, if the user 102 is blind, the name of the user 102 is printed or embossed on the transaction card 104 in Braille. The transaction card 104 is readable by the payment terminal device 108 for obtaining the transaction card details. An example of the transaction card 104 is described in conjunction with FIGS. 2A and 2B.

The user device 106 is a computing device of the user 102. Examples of the user device 106 include, but are not limited to, a mobile phone, a computer, a laptop, a smartphone, a tablet, and a phablet. The user device 106 includes an input mechanism that allows the user 102 to input data to the user device 106 in a predefined message format, for example, Morse code format. Examples of the input mechanism may include a touchscreen, a touch-sensitive display screen, a clickable-button, a touch-sensitive button, or the like. The user device 106 further includes an output mechanism that presents data to the user 102 in Morse code format. Examples of the output mechanism may include the touch-sensitive display screen, an audio generator, a vibration generator, or the like. The user device 106 is configured to receive, from the issuer server 114, various payment transaction messages related to payment transactions performed by using the transaction card 104.

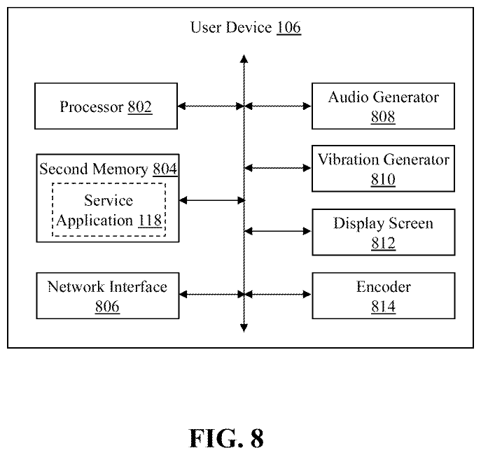

The user device 106 is further configured to execute or run a service application 118 for presenting the received payment transaction messages to the user 102 in Morse code format. In one example, the user device 106 running the service application 118 translates a payment transaction message received from the issuer server 114 to Morse code format and may generate a vibrotactile output (i.e., a vibration pattern in Morse code) for presenting the translated message to the user 102. In another example, the user device 106 running the service application 118 may generate an audio output (i.e., an audio pattern in Morse code) for presenting the translated message to the user 102. In another example, the user device 106 running the service application 118 may generate a visual output (i.e., a visual pattern in Morse code) for presenting the translated message to the user 102. The user device 106 is further configured to receive authentication information, required for processing the payment transactions, from the user 102 in Morse code format. For example, the user 102 may tap the touch-sensitive screen or click the clickable button of the user device 106 for inputting the required authentication information in the Morse code format. The user device 106 running the service application 118 is further configured to translate the authentication information inputted by the user 102 to another message format that is associated and compatible with the issuer server 114 for communicating to the issuer server 114. The service application 118 may be installed on the user device 106 upon issuance of the transaction card 104 to the user 102. Functional details of various components of the user device 106 are described in conjunction with FIG. 8.

The payment terminal device 108 is an electronic device that includes suitable logic, circuitry, interface, and/or code, executable by the circuitry, for facilitating card-based payment transactions. In one example, the payment terminal device 108 may be a Point-of-Sale (POS) device that is associated with a merchant. In such a scenario, the payment terminal device 108 allows the user 102 to perform payment transactions using the transaction card 104 for purchasing products and/or services from the merchant. In another example, the payment terminal device 108 may be an Automated Teller Machine (ATM) that allows the user 102 to access banking services (e.g., cash withdrawals, cash deposits, balance inquiry, and the like) offered by the issuer server 114 or the acquirer server 110 associated with the payment terminal device 108. Other examples of the payment terminal device 108 may include, but are not limited to, a Point-of-Purchase (POP) device, a Point-of-Interaction (POI) device, a currency recycler, a bunch note acceptor, or the like. The payment terminal device 108 communicates with the transaction card 104 in a contactless manner or by way of a contact established therebetween.

The acquirer server 110 is a server arrangement which includes suitable logic, circuitry, interface, and/or code, executable by the circuitry, for processing payment transactions initiated at the payment terminal device 108. The acquirer server 110 is operated by an acquirer associated with the payment terminal device 108. The acquirer server 110 further communicates with the payment network server 112 and the issuer server 114 for processing the payment transactions.

The payment network server 112 is a server arrangement which includes suitable logic, circuitry, interface, and/or code, executable by the circuitry, for processing payment transactions that are performed using the transaction card 104. The payment network server 112 is operated by a payment network (i.e., a payment interchange). The payment network server 112 represents an intermediate entity between the issuer server 114 and the acquirer server 110 for processing the payment transactions.

The issuer server 114 is a server arrangement which includes suitable logic, circuitry, interface, and/or code, executable by the circuitry, for processing various payment transactions. The issuer server 114 is operated by the issuer of the transaction card 104. The issuer is a financial institution that manages one or more payment accounts of various users, e.g., the user 102. Details of the payment accounts established with the issuer are stored as account profiles. Each account profile may be indicative of a payment transaction history of a corresponding user, transaction card details of one or more transaction cards issued to the corresponding user, or the like. The issuer server 114 is configured to receive various transaction requests for processing payment transactions. A received transaction request may include details of a corresponding payment transaction such as a transaction amount, a timestamp of the payment transaction, transaction card details of a transaction card used for initiating the payment transaction, or the like. The issuer server 114 processes each payment transaction by approving or declining, based on the details of the payment transaction. The issuer server 114 further credits, debits, or modifies the payment accounts of the users based on the processing of the payment transactions. Methods of processing the payment transactions via the issuer server 114 will be apparent to persons having skill in the art and may include processing a payment transaction via the traditional four-party system or three-party system.

In one embodiment, the issuer server 114 is configured to assign (or reserve) unique identification numbers to each of a plurality of predefined categories such that transaction cards are issued to users as per their respective predefined categories. For example, the issuer server 114 may assign a first BIN (i.e., the unique identification number) to a first predefined category. Thus, when the user 102, belonging to the first predefined category, requests for a transaction card, the issuer server 114 issues the transaction card 104 having the first BIN, to the user 102. In a similar manner, transaction cards are issued to other users belonging to other predefined categories. The issuer server 114 is further configured to store an assignment database in a memory thereof. The assignment database may store a relationship-mapping between the predefined categories and corresponding assigned identification numbers (i.e., BINs). In a non-limiting example, the plurality of predefined categories include a plurality of differently-abled categories, such as a deaf-blind category, a deaf-mute category, a mute-blind category, or the like. It will be apparent to a person of ordinary skill in the art that the plurality of categories may also include other categories defined by the issuer or the payment network, without deviating from the scope of the disclosure. However, for the sake of ongoing description, the plurality of predefined categories are assumed to be the plurality of differently-abled categories and the user 102 is assumed to belong to a first differently-abled category.

The issuer server 114 is further configured to link issued transaction cards with reference authentication information set for the issued transaction cards by the cardholders. For example, the issuer server 114 links the transaction card 104 with reference authentication information set for the transaction card 104 by the user 102. The link between a transaction card and corresponding reference authentication information may be stored in an authentication database by the issuer server 114. The authentication database may be referred by the issuer server 114 for validating authentication information provided by a cardholder for authentication.

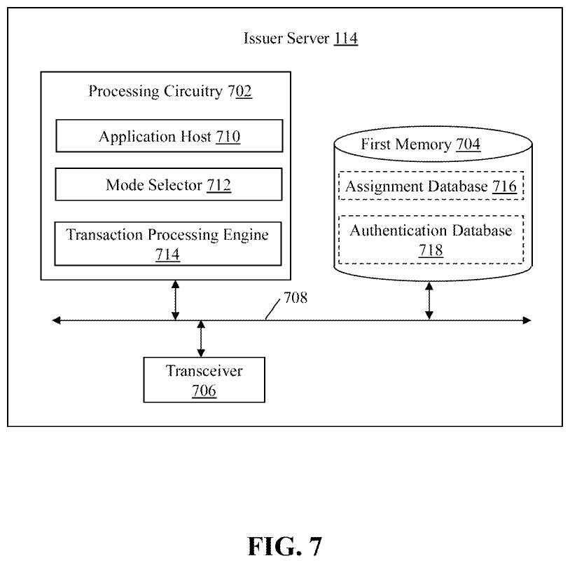

In one embodiment, the issuer server 114 is further configured to host the service application 118 for offering differently-abled users a convenient means to conduct payment transactions. The service application 118 may serve as a gateway to the issuer server 114, thus, any data inputted to the user device 106 through the service application 118 is communicated to the issuer server 114 over the communication network 116. The service application 118 is operable in various operation modes, for example, a visual mode, an audio mode, and a vibration mode. In one embodiment, the user device 106 when executing the service application 118 in the visual mode, translates a message received by the user device 106 to Morse code format and presents the translated message as a visual pattern. In another embodiment, the user device 106 when executing the service application 118 in the visual mode may display the received message in textual format for presenting to the user 102. In one embodiment, the user device 106 when executing the service application 118 in the audio mode, translates the received message to Morse code format and presents the translated message as an audio pattern. In another embodiment, the user device 106 when executing the service application 118 in the audio mode may convert the received message to an audio message (e.g., by text to speech conversion) for presenting to the user 102. The user device 106 when running the service application 118 in the vibration mode, translates the received message to Morse code format and presents the translated message as a vibrotactile pattern. The service application 118 is executable in one of various operation modes depending upon a differently-abled category (i.e., a predefined category). For example, when the user 102 is deaf and blind, the service application 118 is executable on the user device 106 in the vibration mode. Similarly, when the user 102 is mute and blind, the service application 118 is executable on the user device 106 in either the audio mode or the vibration mode. In a similar manner, when the user 102 is deaf and mute, the service application 118 is executable on the user device 106 in either the visual Mode or the vibration mode. Functional details of various components of the issuer server 114 are described in conjunction with FIG. 7.

Examples of the acquirer server 110, the payment network server 112, and the issuer server 114 may include, but are not limited to, computers, laptops, mini-computers, mainframe computers, any non-transient and tangible machines that may execute a machine-readable code, cloud-based servers, distributed server networks, a network of computer systems, or a combination thereof.

The communication network 116 is a medium through which content and messages are transmitted between the user device 106, the payment terminal device 108, the acquirer server 110, the payment network server 112, and/or the issuer server 114. Examples of the communication network 116 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIGS. 2A and 2B are schematic diagrams that illustrate front and back views of the transaction card 104, in accordance with an exemplary embodiment of the present disclosure.

With reference to FIG. 2A, the front view of the transaction card 104 illustrates a first (or front) surface 202a of the transaction card 104. The first surface 202a may contain the name 204 of the cardholder (i.e., the user 102) of the transaction card 104 printed in a visually readable script, such as Latin. In one example, if the cardholder is blind, the name 204 of the cardholder may be printed or embossed in Braille. In one embodiment, the first surface 202a further includes an electronic chip 206a (i.e., the memory element of the transaction card 104) that electronically stores the transaction card details of the transaction card 104. The electronic chip 206a is a machine-readable data storage device (e.g., Europay, Mastercard and Visa chip) by which the payment terminal device 108 obtains the transaction card details of the transaction card 104.

With reference to FIG. 2B, the back view of the transaction card 104 illustrates a second (or back) surface 202b of the transaction card 104. In one embodiment, the second surface 202b includes a magnetic stripe 206b (i.e., another memory element) that stores the transaction card details of the transaction card 104. The magnetic stripe 206b is a machine-readable data storage device by which a magnetic reading head of the payment terminal device 108 obtains the transaction card details of the transaction card 104. The transaction card 104 may further include other types of machine-readable data storage media, such as bar codes, wireless transponder circuits, and/or the like for storing the transaction card details of the transaction card 104.

It will be apparent to a person of ordinary skill in the art that the transaction card 104 in FIGS. 2A and 2B is illustrated for exemplary purpose and should not be construed to limit the scope of the disclosure. In other embodiments, the transaction card 104 may include one of the electronic chip 206a or the magnetic stripe 206b.

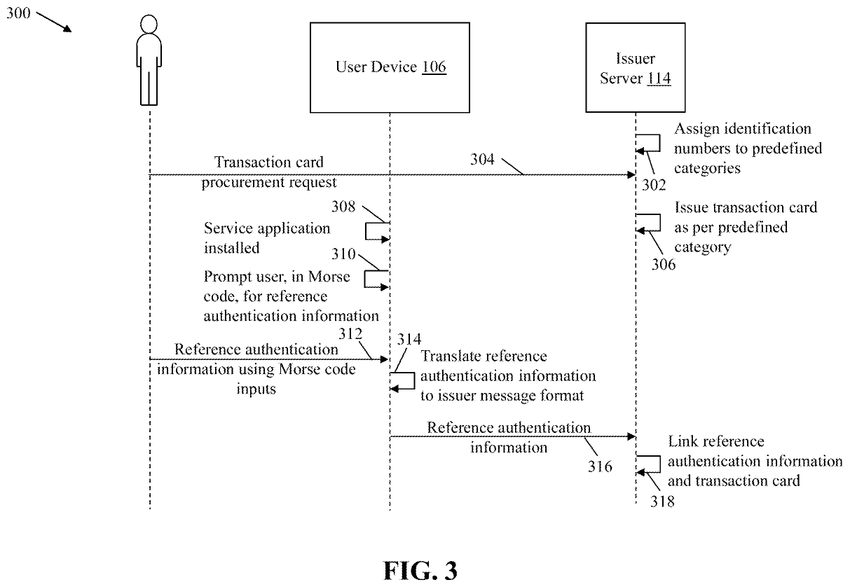

FIG. 3 is a process flow diagram 300 that illustrates issuance of the transaction card 104 to the user 102, in accordance with an exemplary embodiment of the present disclosure.

The issuer server 114 assigns different identification numbers (e.g., unused BINs) to various predefined categories, such as differently-abled categories (as shown by arrow 302). For example, the issuer server 114 may assign BINs ‘21’ and ‘22’ to the first differently-abled category. Upon assigning the identification numbers, the issuer server 114 generates the assignment database (as shown in FIG. 7) that stores the relationship-mapping between the differently-abled categories and the assigned identification numbers (i.e., BINs). In other words, the issuer server 114 stores in the assignment database, the one or more identification numbers that are uniquely assigned to each of the plurality of predefined categories.

The issuer server 114 receives a transaction card procurement request of the user 102 (as shown by arrow 304). The transaction card procurement request is indicative of the first payment account of the user 102 and the first differently-abled category (i.e., the first predefined category) to which the user 102 belongs. Based on the transaction card procurement request, the issuer server 114 manages issuance of the transaction card 104 to the user 102 as per the first differently-abled category (i.e., the first predefined category) of the user 102 (as shown by arrow 306). In other words, the transaction card 104 issued to the user 102 has associated therewith, the identification number that is assigned to the first differently-abled category to which the user 102 belongs. For example, the transaction card number of the transaction card 104 has the BIN ‘22’ that is assigned to the first differently-abled category, associated therewith.

Upon issuance of the transaction card 104 to the user 102, the service application 118 is installed on the registered user device 106 of the user 102 (as shown by arrow 308). In one example, the service application 118 is installed on the user device 106 by the user 102. In another example, an operator of the issuer assists the user 102 in installing the service application 118 on the user device 106. Upon installation, the user device 106 runs or executes the service application 118. The service application 118 is configured to run on the user device 106 in a first operation mode that is compatible and associated with the first differently-abled category of the user 102. For example, when the user 102 is deaf and blind, the service application 118 runs on the user device 106 in the vibration mode. Similarly, when the user 102 is deaf and mute, the service application 118 runs on the user device 106 in the visual mode. Likewise, when the user 102 is mute and blind, the service application 118 runs on the user device 106 in the audio mode.

While running in the first operation mode, the service application 118 causes the user device 106 to prompt, in Morse code, the user 102 to set reference authentication information for the transaction card 104 (as shown by arrow 310). In one example, the service application 118 is running in the vibration mode and causes the user device 106 to generate and present a vibrotactile output in Morse code, prompting the user 102 to set the reference authentication information. The user 102 holding the user device 106 perceives the vibrotactile output by a sense of touch and understands that the user device 106 is prompting to set the reference authentication information for the transaction card 104. Based on the prompting, the user 102 interacts with the user device 106 through Morse code inputs for entering the reference authentication information (as shown by arrow 312). For example, the user 102 may tap the touch-sensitive screen or click the clickable button of the user device 106 as per Morse code format, for inputting the reference authentication information. The user device 106, running the service application 118, receives the reference authentication information in Morse code format and translates the reference authentication information to another message format compatible and associated with the issuer server 114 (as shown by arrow 314). The user device 106 then communicates the translated reference authentication information to the issuer server 114 (as shown by arrow 316).

The issuer server 114 receives the reference authentication information and links the reference authentication information to the transaction card 104 (as shown by arrow 318). The issuer server 114 is configured to store the link between the transaction card 104 and the reference authentication information, in the authentication database (as shown in FIG. 7). Upon storing the link, the transaction card 104 is activated for use.

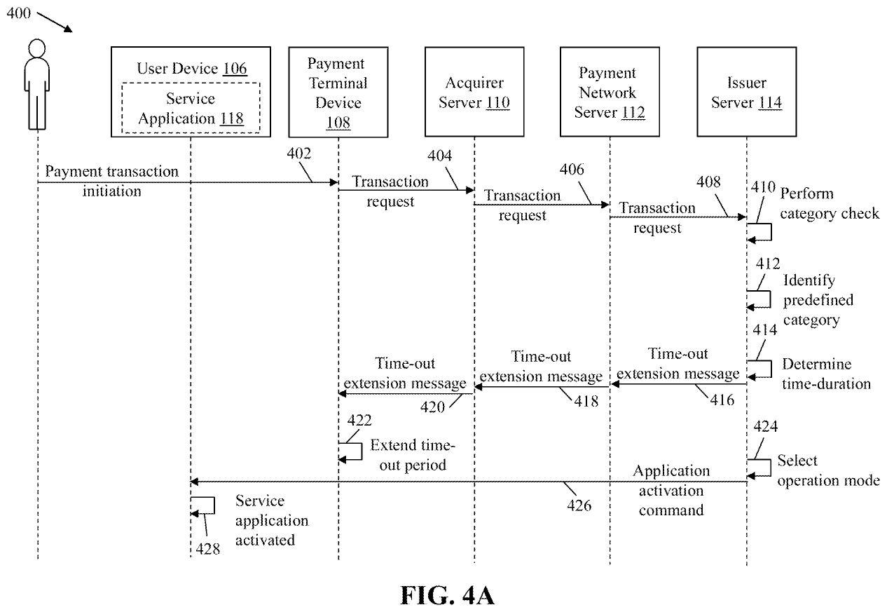

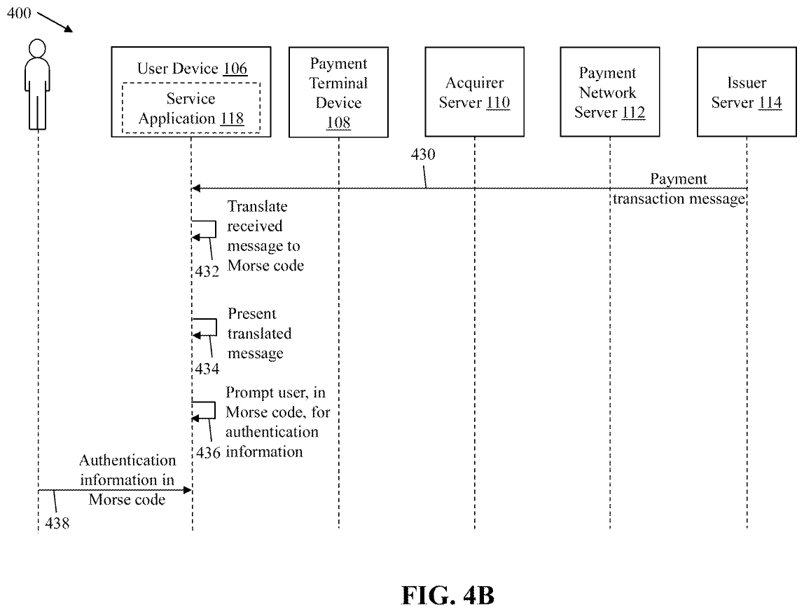

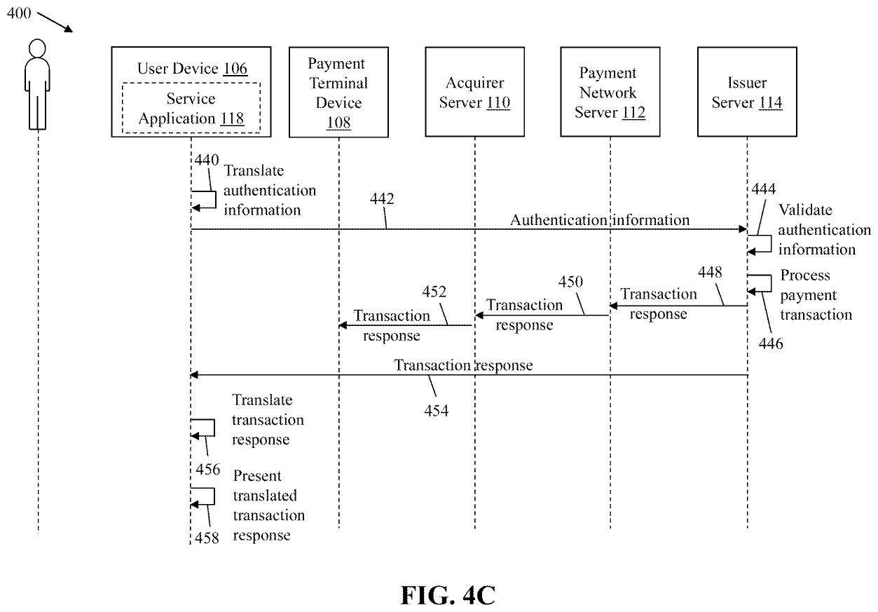

FIGS. 4A, 4B, and 4C, collectively represent a process flow diagram 400 that illustrates facilitation of a payment transaction by the issuer server 114, in accordance with an exemplary embodiment of the present disclosure.

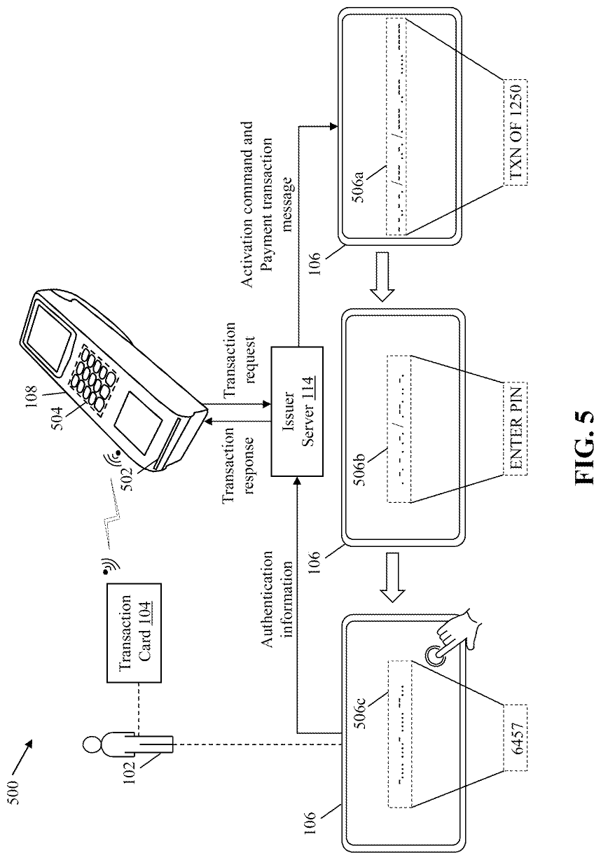

With reference to FIG. 4A, the user 102 initiates a payment transaction at the payment terminal device 108 using the transaction card 104 (as shown by arrow 402). The payment terminal device 108, via a transaction card reader therein (as shown in FIG. 5), reads the transaction card details from the electronic chip 206a or the magnetic stripe 206b. The payment terminal device 108 then transmits a transaction request to the acquirer server 110 associated with the payment terminal device 108 (as shown by arrow 404). The transaction request includes details such as a transaction amount, a timestamp of the payment transaction, transaction card details of the transaction card 104, or the like. In other words, the payment terminal device 108, by way of the transaction request, communicates the details of the payment transaction to the acquirer server 110 for processing the payment transaction.

The acquirer server 110 receives the transaction request from the payment terminal device 108 and in turn, identifies the payment network server 112 associated with the transaction card 104. The acquirer server 110 then transmits the received transaction request to the identified payment network server 112 (as shown by arrow 406). The payment network server 112 receives the transaction request, identifies the issuer server 114 associated with the transaction card 104, and transmits the received transaction request to the identified issuer server 114 (as shown by arrow 408).

The issuer server 114 receives the transaction request from the payment network server 112. The issuer server 114 then performs a category check to determine whether the first identification number (i.e., the BIN) of the transaction card 104 is assigned to any differently-abled category (as shown by arrow 410). In other words, the issuer server 114 determines whether the first identification number (i.e., the BIN) of the transaction card 104 is assigned to any predefined category stored in the assignment database. In the current embodiment, the issuer server 114 determines that the first identification number is assigned to a differently-abled category. The issuer server 114 then refers to the assignment database to identify the differently-abled category (i.e., the predefined category) of the user 102 to which the first identification number is assigned (as shown by arrow 412). By referring to the assignment database, the issuer server 114 identifies that the first identification number is assigned to the first differently-abled category. The issuer server 114 further determines a first time-duration for extending a time-out period for the initiated payment transaction, based on the identification of the first differently-abled category (as shown by arrow 414). The time-out period for the payment transaction indicates a time period after which the payment terminal device 108 times-out and declines the payment transaction, if no transaction response is received from the issuer server 114. For example, the time-out period for the payment terminal device 108 may be 120 seconds. Thus, if no transaction response is received from the issuer server 114 within 120 seconds of the initiation of the payment transaction, the payment terminal device 108 times-out and declines the payment transaction. The determination of the first time-duration may be based on the identified differently-abled category and prior user interactions with the service application 118. In one embodiment, the issuer server 114 may have defined different time-durations for various differently-abled categories for extending time-out periods. The issuer server 114 may further customize the defined different time-duration for a differently-abled user as per previous interactions of the differently-abled user with the service application 118. For example, if the differently-abled user had taken more time than the time duration defined for the corresponding differently-abled category to interact with the service application 118 in the past, the issuer server 114 customizes (i.e., increases) the defined time-duration for the differently-abled user. In one example, the issuer server 114 determines the first time-duration to be 300 seconds. The issuer server 114 communicates a time-out extension message to the payment terminal device 108 by way of the payment network server 112 and the acquirer server 110 channel (as shown by arrows 416, 418, and 420). The time-out extension message is indicative of the determined first time-duration. Based on the time-out extension message, the payment terminal device 108 extends the time-out period to the first time-duration (as shown by arrow 422). Thus, after extension, the new time-out period for the payment transaction is 300 seconds.

The issuer server 114 selects the operation mode of the service application 118 that is compatible and associated with the identified first differently-abled category (as shown by arrow 424). An operation mode of the service application 118 is said to be compatible and associated with a predefined category when various outputs generated by user devices executing the service application 118 in the compatible operation mode are capable of being interpreted by users belonging to the predefined category. In a non-limiting example, it is assumed that the first differently-abled category is deaf-blind category. Thus, the issuer server 114 selects the vibration mode for the service application 118. The issuer server 114 communicates an application activation command to the user device 106 (as shown by arrow 426) to remotely activate the service application 118, installed on the user device 106, in the selected operation mode. The user device 106 receives the application activation command from the issuer server 114, and the service application 118 is remotely activated in the selected operation mode (i.e., the vibration mode) on the user device 106 (as shown by arrow 428).

With reference to FIG. 4B, the issuer server 114 communicates a payment transaction message to the user device 106 to notify the user 102 regarding the initiation of the payment transaction (as shown by arrow 430). The issuer server 114 may communicate the payment transaction message in the form of a short messaging service (SMS) message on a registered contact number of the user 102, an electronic mail (email) on a registered email address of the user 102, or an in-app notification on the service application 118. The payment transaction message may be indicative of the transaction amount, the timestamp of the payment transaction, or the like. The user device 106 receives the payment transaction message and the activated service application 118 detects the received payment transaction message.

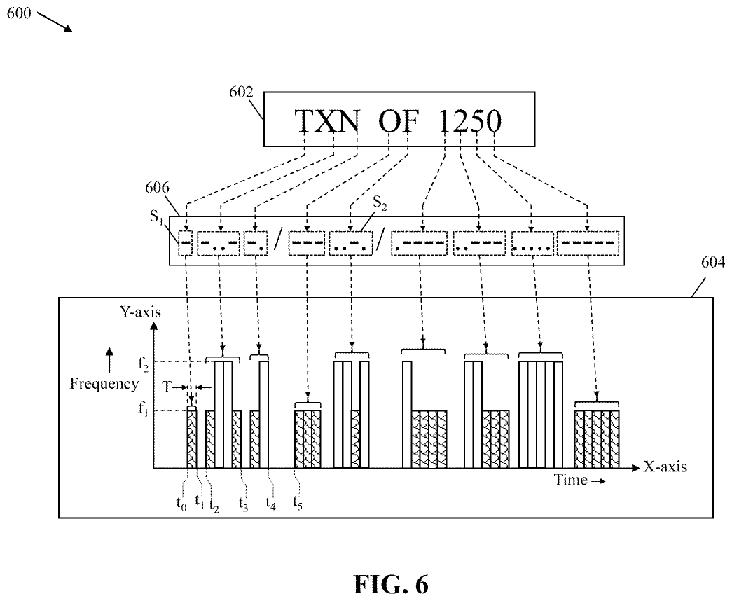

The activated service application 118 then causes the user device 106 to translate the received payment transaction message to Morse code format (as shown by arrow 432). The user device 106 then presents the translated payment transaction message to the user 102 (as shown by arrow 434). The presentation of the translated payment transaction message to the user 102 depends on the operation mode in which the service application 118 is operating. For example, when the service application 118 is activated in the vibration mode, the translated payment transaction message is presented to the user 102 as the vibrotactile output, i.e., a vibration pattern in Morse code. Similarly, if the service application 118 were activated in the audio mode, the translated payment transaction message is presented to the user 102 as the audio output, i.e., an audio pattern in Morse code. In a similar manner, if the service application 118 were activated in the visual mode, the translated payment transaction message is presented to the user 102 as the visual output, i.e., a visual pattern in Morse code. The presentation of the translated payment transaction message is described in more detail in conjunction with FIGS. 5 and 6.

In the current exemplary scenario, the service application 118 is assumed to be activated in the vibration mode. Thus, the user 102, holding the user device 106, perceives the vibrotactile output by the sense of touch and understands that a payment transaction for a specific transaction amount (e.g., $1,250) is initiated using the transaction card 104. The service application 118 further causes the user device 106 to prompt, in Morse code, the user 102 to input authentication information of the transaction card 104 (as shown by arrow 436). As the service application 118 is activated in the vibration mode, the service application 118 causes the user device 106 to generate and present a vibrotactile output in Morse code, prompting the user 102 to input the authentication information. The user 102 perceives the vibrotactile output and understands that the user device 106 is prompting to input the authentication information of the transaction card 104. Based on the prompting, the user 102 interacts with the service application 118 for entering first authentication information in Morse code format (as shown by arrow 438). For example, the user 102 may tap the touch-sensitive screen or click the clickable button of the user device 106 for entering the first authentication information in the Morse code format. When the user 102 taps the touch-sensitive screen or clicks the clickable button of the user device 106, a user interface of the service application 118 is activated on the user device 106.

With reference to FIG. 4C, the user device 106, executing the service application 118, receives the first authentication information in Morse code format and translates the first authentication information to another message format compatible with the issuer server 114 (as shown by arrow 440). The user device 106 then communicates the translated first authentication information to the issuer server 114 (as shown by arrow 442). The issuer server 114 is further configured to validate the received first authentication information for authenticating the user 102 (as shown by arrow 444). For validation, the issuer server 114 refers to the authentication database to determine whether the first authentication information matches the reference authentication information of the transaction card 104. The user 102 is successfully authenticated when the reference authentication information of the transaction card 104 matches the first authentication information. Upon successful authentication of the user 102, the issuer server 114 processes the payment transaction (as shown by arrow 446). For example, the issuer server 114 may authorize the payment transaction and deduct the transaction amount from the first payment account linked to the transaction card 104.

Based on the processing of the payment transaction, the issuer server 114 generates a transaction response. The transaction response indicates whether the payment transaction is approved or declined by the issuer server 114. In a scenario where the payment transaction is declined, the transaction response further indicates a reason for decline. The issuer server 114 then communicates the transaction response to the payment terminal device 108 via the payment network server 112 and the acquirer server 110 channel (as shown by arrows 448, 450, and 452) and the user device 106 (as shown by arrow 454). The activated service application 118 then causes the user device 106 to translate the received transaction response to Morse code format (as shown by arrow 456). The user device 106 then presents the translated transaction response to the user 102 (as shown by arrow 458). For example, the service application 118 operating in the vibration mode causes the user device 106 to present the translated transaction response to the user 102 as the vibrotactile output, i.e., a vibration pattern.

In another embodiment, the service application 118 may be hosted by the payment network server 112. In such a scenario, the operations such as the assignment of the identification numbers to the differently-abled categories, the identification of the differently-abled category of the user 102, the selection of operation mode for the service application 118, and the activation of the service application 118 on the user device 106 are performed by the payment network server 112, without deviating from the scope of the disclosure.

FIG. 5 is a schematic diagram that illustrates an exemplary scenario 500 for facilitating a payment transaction conducted by the user 102 at the payment terminal device 108 using the transaction card 104, in accordance with an exemplary embodiment of the present disclosure. In a non-limiting example, the payment terminal device 108 is shown to be a POS device in FIG. 5.

The payment terminal device 108 is a payment device that is used to process card present payment transactions. The payment terminal device 108 comprises a transaction card reader 502 and a keypad 504. The payment terminal device 108 is enabled for both contactless and contact-based payment transactions. The transaction card reader 502 is an electronic device that is configured to read encrypted transaction card details stored in a memory element (e.g., the electronic chip 206a or the magnetic stripe 206b) of a transaction card (e.g., the transaction card 104) during a contact-based payment transaction or a contactless payment transaction. In one embodiment, the transaction card reader 502 reads the transaction card details when the transaction card 104 is inserted into or swiped at the transaction card reader 502. In another embodiment, the transaction card reader 502 reads the transaction card details when the transaction card 104 is tapped at the payment terminal device 108. The keypad 504 of the payment terminal device 108 is operable for manually providing additional transactional data, e.g., an amount of the payment transaction, required for processing the payment transaction.

In an implementation example, the user 102 uses the transaction card 104 at the payment terminal device 108 to initiate the payment transaction. The payment terminal device 108 communicates the transaction request to the issuer server 114. The issuer server 114 identifies the first differently-abled category of the user 102 and communicates the time-out extension message to the payment terminal device 108 for extending the time-out period for the payment transaction. The issuer server 114 further communicates the application activation command to the user device 106 to remotely activate the service application 118 on the user device 106 in the first operation mode (e.g., the visual mode) that is compatible and associated with the first differently-abled category (e.g., the deaf-mute category) of the user 102. The service application 118 is activated in the first operation mode based on the application activation command, and the issuer server 114 further communicates the payment transaction message (i.e., “TXN OF 1250”) to the user device 106.

The service application 118 running in the first operation mode on the user device 106 causes the user device 106 to translate the received payment transaction message (i.e., “TXN OF 1250”) to Morse code format and present the translated payment transaction message to the user 102. Since the service application 118 is running in the visual mode, the payment transaction message is presented as a first visual pattern 506a which is in Morse code format. The activated service application 118 then causes the user device 106 to prompt the user 102 for inputting the authentication information. The user device 106 prompts the user 102 to “ENTER PIN” by presenting a second visual pattern 506b in Morse code format. Based on the prompting, the user 102 taps the touch-sensitive display screen of the user device 106 (as shown in FIG. 5) to input the authentication information 506c in Morse code, i.e., the PIN “6457”. In one embodiment, when the user 102 taps the touch-sensitive display screen, a vibrotactile output is generated to indicate the tapping. The user device 106 then translates the inputted authentication information 506c to another message format compatible and associated with the issuer server 114 and communicates the translated authentication information to the issuer server 114.

Thus, contrary to receiving the payment transaction message on the payment terminal device 108, the user 102 is presented with the payment transaction message on the user device 106 in a message format that is recognized and understood by the user 102. Further, the user 102 is no longer required to provide the authentication information using the keypad 504. As shown in FIG. 5, the user 102 conveniently enters the authentication information in Morse code format using the service application 118 on the user device 106.

In another embodiment, the visual mode of the service application 118 may have one or more user-configurable settings that allow the user 102 to view the payment transaction message without being translated to the Morse code format. In such a scenario, the payment transaction message is displayed to the user 102 by the user device 106 without translation.

In another implementation example, the first operation mode may be the vibration mode. Thus, the translated payment transaction message (i.e., “TXN OF 1250”) is presented to the user 102 as a first vibration pattern, in Morse code format. Similarly, the user device 106 prompts the user 102 to input the authentication information by outputting a second vibration pattern, in Morse code format. When the user 102 taps the touch-sensitive display screen of the user device 106 to input the authentication information, a third vibration pattern is outputted by the user device 106 to indicate the user 102 regarding the tapping of the touch-sensitive display screen. In the first through third vibration patterns, different Morse code characters (e.g., Dit and Dah or Dot and Dash) are outputted as different vibration frequencies (as shown in FIG. 6), thereby enabling the user 102 to differentiate between the different Morse code characters by the sense of touch.

In another implementation example, the first operation mode may be the audio mode. Thus, the translated payment transaction message (i.e., “TXN OF 1250”) is presented to the user 102 as a first audio pattern in Morse code format or a first audio message. Similarly, the user device 106 prompts the user 102 to input the authentication information by outputting a second audio pattern in Morse code format or a second audio message. When the user 102 taps the touch-sensitive display screen of the user device 106 to input the authentication information, a third audio pattern in Morse code format is outputted by the user device 106 to indicate the user 102 regarding the tapping of the touch-sensitive display screen. In one embodiment, when the user 102 taps the touch-sensitive display screen, a vibrotactile output is generated with or without the third audio pattern to indicate the tapping. In the first through third audio patterns, different Morse code characters (e.g., Dit and Dah or Dot and Dash) are outputted as different audio frequencies, thereby enabling the user 102 to differentiate between the different Morse code characters by the sense of hearing.

In another implementation example, the payment terminal device 108 may be an ATM. It will be apparent to a person of ordinary skill in the art that the user 102 may perform a payment transaction at the ATM in a similar manner as described above for the POS device.

FIG. 6 is a schematic diagram 600 that illustrates translation of a payment transaction message 602 to a vibration pattern 604 in Morse code format, in accordance with an exemplary embodiment of the present disclosure.

The payment transaction message 602 is a text message that includes various characters. The user device 106, executing the service application 118 in the vibration mode, translates the payment transaction message 602 to Morse code 606. For example, the letter “T” of the payment transaction message 602 is translated to obtain S₁ in Morse code such that S₁ includes the Morse code character Dah (or Dash). Similarly, the letter “F” of the payment transaction message 602 is translated to obtain S₂ in Morse code such that S₂ is a combination of Morse code characters Dit, Dit, Dah, and Dit, in sequence. Similarly, other characters of the payment transaction message 602 are translated to obtain the Morse code 606.

The user device 106 then encodes different Morse code characters (e.g., Dit and Dah) in the Morse code 606 to different vibrotactile frequencies (e.g., f₁ and f₂). For example, the Morse code character Dah is encoded into a first vibrotactile frequency f₁ (e.g., 5 Hz) that lasts for a time duration T and the Morse code character Dit is encoded into a second vibrotactile frequency f₂ (e.g., 10 Hz) that lasts for the time duration T. Further, separation between two consecutive letters in the payment transaction message 602 is represented by a first time-period of rest. The separation between two consecutive words of the payment transaction message 602 is represented by a second-time period of rest such that the second time-period is longer than the first time-period.

Based on the encoding, the user device 106 obtains the vibration pattern 604 for the Morse code 606. In the vibration pattern 604, the x-axis represents time and the y-axis represents frequency. The interval between time instances t₀ and t₁, including the first vibrotactile output that lasts for time duration T, corresponds to the letter “T” of the payment transaction message 602. Similarly, the interval between time instances t₀ and t₃ represents the letter “X” of the payment transaction message 602. The interval between time instances t₂ and t₃ equals the time duration 4T and includes the first vibrotactile output followed by two second vibrotactile outputs and one first vibrotactile output, in sequence. The interval between time instances t₁ and t₂ includes no vibrotactile output and represents separation between the letters “T” and “X” of the payment transaction message 602. Similarly, the interval between time instances t₄ and t₅ includes no vibrotactile output and represents the separation between two consecutive words “TXN” and “OF” of the payment transaction message 602. The user device 106 generates the first and second vibrotactile outputs as per the vibration pattern 604 to present the payment transaction message 602 to the user 102 in Morse code format.

In another embodiment, when the service application 118 is activated in the audio mode, the user device 106 encodes different Morse code characters (e.g., Dit and Dah) in the Morse code 606 to different audio frequencies (e.g., f₁ and f₂) for obtaining the audio pattern to present to the user 102. For example, the Morse code character Dah is encoded into a first audio frequency f₁ that lasts for a time duration T and the Morse code character Dit is encoded into a second audio frequency f₂ that lasts for the time duration T.

It will be apparent to a person of ordinary skill in the art that the scope of the disclosure is not limited to encoding of different Morse code characters in different vibrotactile or audio frequencies. In another embodiment, different Morse code characters may be encoded into different vibrotactile or audio amplitudes. For example, the user device 106 may generate vibrotactile or audio outputs having different amplitudes for different Morse code characters. In another embodiment, different Morse code characters may be encoded into different vibrotactile or audio time-periods. For example, the user device 106 may generate vibrotactile or audio outputs having different time durations for different Morse code characters.

It will be apparent to a person of skill in the art that the scope of the present disclosure is not limited to translating the payment transaction message 602 to the Morse code 606 and encoding the Morse code 606 to the vibration pattern 604 or the audio pattern by using the techniques mentioned above. Various other techniques exist and are well known to those of ordinary skill in the art and the details of such techniques are avoided for the sake of brevity.

FIG. 7 is a block diagram that illustrates the issuer server 114, in accordance with an exemplary embodiment of the present disclosure. The issuer server 114 includes processing circuitry 702, a first memory 704, and a transceiver 706. The processing circuitry 702, the first memory 704, and the transceiver 706 communicates with each other by way of a communication bus 708. The processing circuitry 702 includes an application host 710, a mode selector 712, and a transaction processing engine 714.

The processing circuitry 702 includes suitable logic, circuitry, interfaces, and/or code, executed by the circuitry, for processing the payment transactions performed by way of the transaction card 104. Examples of the processing circuitry 702 may include, but are not limited to, an application-specific integrated circuit (ASIC) processor, a reduced instruction set computer (RISC) processor, a complex instruction set computer (CISC) processor, a field programmable gate array (FPGA), a central processing unit (CPU), or a microprocessor. The processing circuitry 702 executes various transaction processing operations by way of the application host 710, the mode selector 712, and the transaction processing engine 714.

The first memory 704 includes suitable logic, circuitry, and/or interfaces to store various instructions or code which when executed by the processing circuitry 702 causes the processing circuitry 702 to perform the transaction processing operations. The first memory 704 further stores the assignment database (hereinafter, referred to and designated as “the assignment database 716”). The assignment database 716 may be a tabular database or a graphical database that stores the relationship-mapping between various predefined categories (e.g., the plurality of differently abled categories) and corresponding assigned identification numbers (i.e., BINs). In one example, the assignment database 716 includes a record that indicates that the first differently-abled category is assigned with the BINs ‘21’ and ‘22’. The first memory 704 further stores the authentication database (hereinafter, referred to and designated as “the authentication database 718”). The authentication database 718 may include links between transaction cards and corresponding reference authentication information. In one example, the authentication database 718 includes a record indicating that the reference authentication information of the transaction card 104 is “6457”. Examples of the first memory 704 may include a random-access memory (RAM), a read-only memory (ROM), a removable storage drive, a hard disk drive (HDD), a flash memory, a solid-state memory, or the like. It will be apparent to a person skilled in the art that the scope of the disclosure is not limited to realizing the first memory 704 in the issuer server 114, as described herein. In another embodiment, the first memory 704 may be realized in form of a database server or a cloud storage working in conjunction with the issuer server 114, without departing from the scope of the disclosure.

The transceiver 706 includes suitable logic, circuitry, interfaces, and/or code, executable by the circuitry, to transmit and receive data over the communication network 116 using one or more communication network protocols. The transceiver 706 transmits requests and messages to and receives requests and messages from the payment network server 112 and the user device 106 (as described in conjunction with FIGS. 1-6). Examples of the transceiver 706 includes, but are not limited to, an antenna, a radio frequency transceiver, a wireless transceiver, a Bluetooth transceiver, an ethernet port, a universal serial bus (USB) port, or any other device configured to transmit and receive data.

The application host 710 is configured to host the service application 118 which is executable on various user devices in various operation modes. The application host 710 is further configured to generate updates for introducing new functionalities and fixing previous bugs in the service application 118. The application host 710 is further configured to remotely activate the service application 118 that is installed on the user device 106 in an operation mode that is compatible and associated with the differently-abled category of the user 102 of the user device 106.

The mode selector 712 is configured to select one of the operation modes for the service application 118 installed on the user device 106 based on the identified predefined (i.e., the identified differently-abled category) of the user 102. For example, when the user 102 is deaf and blind, the mode selector 712 selects the vibration mode for the service application 118.

The transaction processing engine 714 processes the payment transaction based on the transaction request received by the issuer server 114. The transaction processing engine 714 processes the payment transaction (e.g., authorize or decline the payment transaction) and communicates the transaction response to the payment network server 112 and the user device 106. For example, the transaction processing engine 714 authenticates the user 102 for the payment transaction based on a comparison between the first authentication information provided by the user 102 and the reference authentication information linked to the transaction card 104. The transaction processing engine 714 further determines whether the first payment account linked to the transaction card 104 has sufficient funds to cover the transaction amount of the payment transaction. In one example, the transaction processing engine 714 may determine that the first payment account has sufficient funds to cover the transaction amount and authorize the payment transaction. In another example, the transaction processing engine 714 may determine that the first payment account does not have sufficient funds to cover the transaction amount, and decline the payment transaction. The transaction processing engine 714 further assigns different identification numbers to various predefined categories (e.g., the plurality of differently-abled categories) for transaction card issuance. The transaction processing engine 714 is further configured to link issued transaction cards with reference authentication information provided by corresponding cardholders, and update the authentication database 718 to store the newly generated links.

It will be apparent to a person of ordinary skill in the art that when the service application 118 is hosted by the payment network server 112, the payment network server 112 includes the processing circuitry 702, the first memory 704, and the transceiver 706 for performing operations such as the identification of the differently-abled category of the user 102, the selection of operation mode for the service application 118, and the remote activation of the service application 118 on the user device 106, without deviating from the scope of the disclosure.

FIG. 8 is a block diagram that illustrates the user device 106, in accordance with an embodiment of the present disclosure. The user device 106 includes a processor 802, a second memory 804, a network interface 806, an audio generator 808, a vibration generator 810, a display screen 812, and an encoder 814.

The processor 802 includes suitable logic, circuitry, interfaces, and/or code, executed by the circuitry, for controlling various operations of the user device 106. Examples of the processor 802 includes, but are not limited to, an ASIC processor, a RISC processor, a CISC processor, an FPGA, a CPU, a microprocessor, or a microcontroller.

The second memory 804 includes suitable logic, circuitry, and/or interfaces for storing various instructions or code which when executed by the processor 802 causes the processor 802 to perform corresponding operations. The second memory 804 is configured to store an operating system or a firmware using which the processor 802 operates. The second memory 804 further stores personal data of the user 102, e.g., images, documents, or the like. The second memory 804 further stores application programs of various service applications (e.g., the service application 118) installed on the user device 106. Examples of the second memory 804 includes, but are not limited to, a RAM, a ROM, a removable storage drive, an HDD, a flash memory, or a solid-state memory.

The network interface 806 includes suitable logic, circuitry, interfaces, and/or code, executed by the circuitry, to transmit and receive data over the communication network 116 using one or more communication network protocols. The network interface 806 transmits requests and messages to and receives requests and messages from the issuer server 114. Examples of the network interface 806 includes, but are not limited to, an antenna, a radio frequency network interface, a wireless network interface, a Bluetooth network interface, an ethernet port, a USB port, or any other device configured to transmit and receive data.

The audio generator 808 includes suitable logic, circuitry, interfaces, and/or code, executed by the circuitry, to generate audio signals, for example, the audio pattern, of varying frequencies, amplitudes, and time-duration. In one example, the audio generator 808 is a speaker. The audio generator 808 is configured to output the audio pattern for presenting messages and requests to the user 102 in Morse code format.

The vibration generator 810 includes suitable logic, circuitry, interfaces, and/or code, executed by the circuitry, to generate vibrotactile outputs (for example, the vibration pattern 604) of varying frequencies, amplitudes, and time-duration. The audio generator 808 is configured to output the vibration pattern (e.g., the vibration pattern 604) for presenting messages and requests to the user 102 in Morse code format.

The display screen 812 includes suitable logic, circuitry, and/or interfaces that are operable to execute one or more instructions stored in the second memory 804 to perform display operations. For example, the display screen 812 displays one or more user interfaces of the service application 118. The display screen 812 may be a touch-sensitive display that is utilized by the user 102 for Morse code interactions with the user device 106. For example, as shown in FIG. 6, the user 102 may tap on the display screen 812 to enter the reference authentication information and the first authentication information in Morse code format. Examples of the display screen 812 includes, but are not limited to, a thin film transistor liquid crystal display (TFT LCD), an in-plane switching (IPS) LCD, a Resistive Touchscreen LCD, a Capacitive Touchscreen LCD, an organic light emitting diode (OLED), an active-matrix organic light emitting diode (AMOLED), a Super AMOLED, a Retina Display, and a Haptic/Tactile touchscreen.

The encoder 814 is configured to encode a Morse code message (e.g., the Morse code 606) to one of the first and second vibrotactile outputs (as shown in FIG. 6) or the first and second audio outputs for presenting to the user 102. When the service application 118 is activated in the audio mode, the encoder 814 encodes different Morse code characters to the first and second audio outputs that vary in terms of frequency, amplitude, or time-period. Similarly, when the service application 118 is activated in the vibration mode, the encoder 814 encodes different Morse code characters to the first and second vibrotactile outputs that vary in terms of frequency, amplitude, or time-period. Based on the encoding, a Morse code message is converted to an audio pattern or a vibration pattern outputted by the audio generator 808 or the vibration generator 810, respectively.

It will be apparent to a person of ordinary skill in the art that the scope of the user device 106 is not limited to include the components illustrated in FIG. 8. The user device 106 may further include additional components such as a microphone, the clickable button, a rechargeable battery, a charging port, or the like, without deviating from the scope of the disclosure.

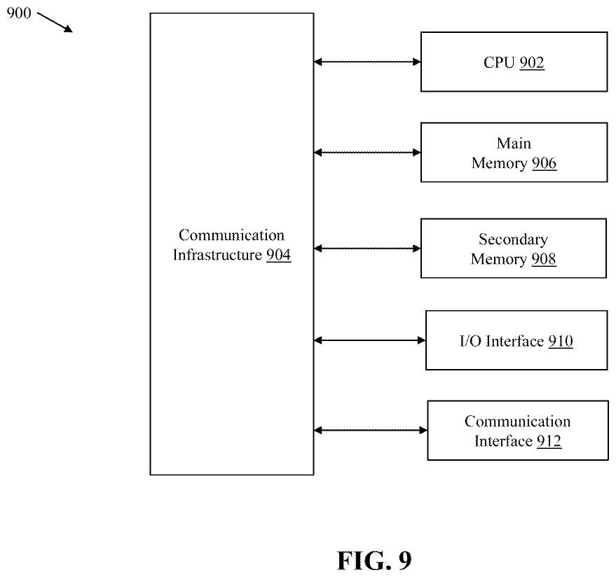

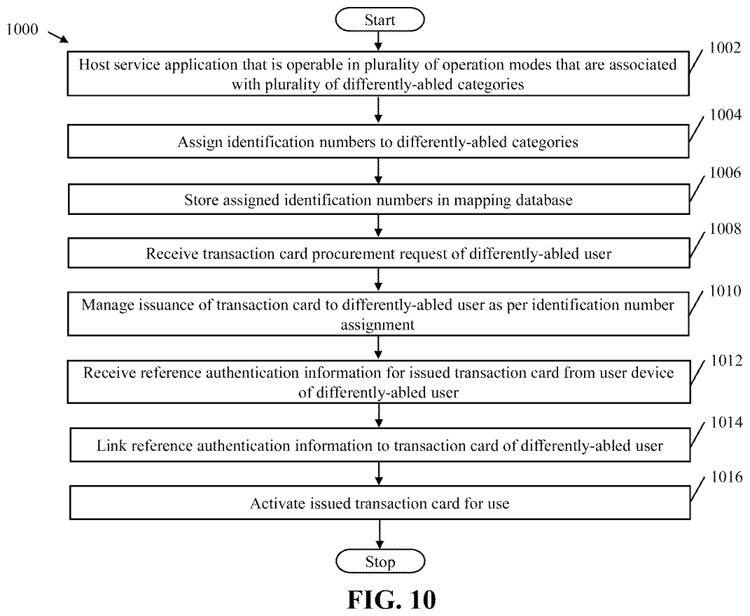

FIG. 9 is a block diagram that illustrates a system architecture of a computer system 900, in accordance with an embodiment of the present disclosure. An embodiment of present disclosure, or portions thereof, may be implemented as computer readable code on the computer system 900. In one example, the user device 106, the payment terminal device 108, the acquirer server 110, and the payment network server 112, and the issuer server 114 may be implemented as the computer system 900. Hardware, software, or any combination thereof may embody modules and components used to implement the methods of FIGS. 10, 11A-11B, and 12.

The computer system 900 includes a CPU 902 that may be a special-purpose or a general-purpose processing device. The CPU 902 may be a single processor, multiple processors, or combinations thereof. The CPU 902 may have one or more processor cores. In one example, the CPU 902 is an octa-core processor. Further, the CPU 902 may be connected to a communication infrastructure 904, such as a bus, message queue, multi-core message-passing scheme, and the like. The computer system 900 may further include a main memory 906 and a secondary memory 908. Examples of the main memory 906 may include RAM, ROM, and the like. The secondary memory 908 may include a hard disk drive or a removable storage drive, such as a floppy disk drive, a magnetic tape drive, a compact disc, an optical disk drive, a flash memory, and the like.

The computer system 900 further includes an input/output (I/O) interface 910 and a communication interface 912. The I/O interface 910 includes various input and output devices that are configured to communicate with the CPU 902. Examples of the input devices may include a keyboard, a mouse, a joystick, a touchscreen, a microphone, and the like. Examples of the output devices may include a display screen, a speaker, headphones, and the like. The communication interface 912 may be configured to allow data to be transferred between the computer system 900 and various devices that are communicatively coupled to the computer system 900. Examples of the communication interface 912 may include a modem, a network interface, i.e., an Ethernet card, a communication port, and the like. Data transferred via the communication interface 912 may correspond to signals, such as electronic, electromagnetic, optical, or other signals as will be apparent to a person skilled in the art.

FIG. 10 is a flowchart 1000 that illustrates a method for issuing the transaction card 104 to the user 102, in accordance with an exemplary embodiment of the present disclosure.

At step 1002, the issuer server 114 hosts the service application 118 that is operable in the plurality of operation modes that are compatible and associated with the plurality of differently-abled categories. At step 1004, the issuer server 114 assigns identification numbers (e.g., unused BINs) to the differently-abled categories. At step 1006, the issuer server 114 stores the assigned identification numbers (e.g., unused BINs) in the assignment database 716. At step 1008, the issuer server 114 receives the transaction card procurement request of the user 102, who is differently abled. The transaction card procurement request is indicative of the first differently-abled category to which the user 102 belongs. At step 1010, the issuer server 114 manages the issuance of the transaction card 104 to the user 102 as per the identification number assignment. Thus, the transaction card 104 issued to the user 102 has the identification number that is assigned to the first differently-abled category to which the user 102 belongs. At step 1012, the issuer server 114 receives the reference authentication information for the issued transaction card 104 from the user device 106 of the user 102. The reference authentication information is entered by the user 102 in Morse code format, using the service application 118 being executed on the user device 106 in the first operation mode that is compatible and associated with the first differently-abled category of the user 102. The reference authentication information received by the issuer server 114 is in a message format that is associated with the issuer server 114. At step 1014, the issuer server 114 links the reference authentication information to the transaction card 104. The issuer server 114 stores the link between the transaction card 104 and the reference authentication information, in the authentication database 718. At step 1016, the issuer server activates the transaction card 104 for use.

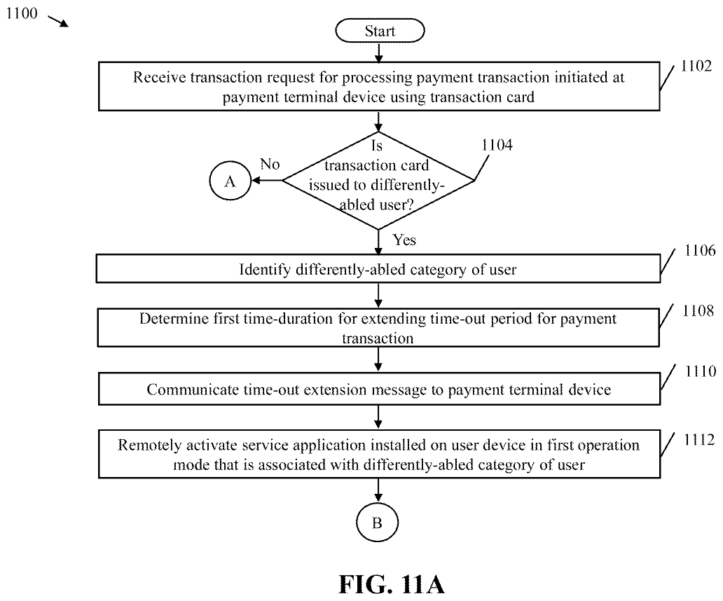

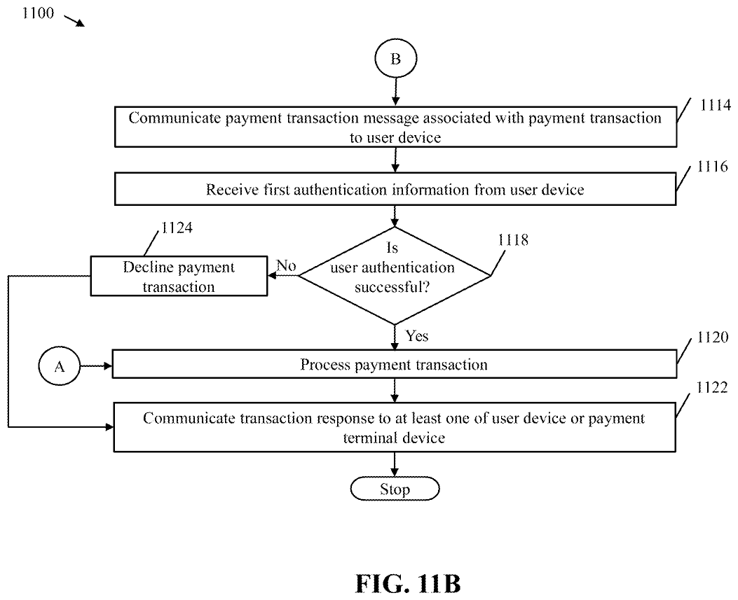

FIGS. 11A and 11B, collectively represent a flowchart 1100 that illustrates a method for facilitating a payment transaction, in accordance with an exemplary embodiment of the present disclosure.

With reference to FIG. 11A, at step 1102, the issuer server 114 receives the transaction request upon initiation of the payment transaction using the transaction card 104 at the payment terminal device 108. At step 1104, the issuer server 114 determines whether the transaction card 104 is issued to a differently-abled user, based on the identification number (i.e., the BIN) of the transaction card 104. If at step 1104, the issuer server 114 determines that the transaction card 104 is issued to a differently-abled user, step 1106 is executed. At step 1106, the issuer server 114 identities the differently-abled category of the user 102 based on the received transaction request. For example, the issuer server 114 refers to the assignment database 716 using the identification number (i.e., the BIN) included in the transaction request for identifying the differently-abled category of the user 102.

At step 1108, the issuer server 114 determines the first time-duration for extending the time-out period for the payment transaction. At step 1110, the issuer server 114 communicates the time-out extension message, indicating the first time-duration, to the payment terminal device 108 for extending the time-out period. Based on the time-out extension message, the payment terminal device 108 extends the time-out period for the payment transaction. At step 1112, the issuer server 114 remotely activates the service application 118 on the user device 106 in the first operation mode which is compatible and associated with the identified first differently-abled category of the user 102.

With reference to FIG. 11B, at step 1114, the issuer server 114 communicates the payment transaction message associated with the payment transaction to the user device 106. The payment transaction message (e.g., the payment transaction message 602) is indicative of the transaction amount of the payment transaction. The activated service application 118 causes the user device 106 to translate the received payment transaction message to Morse code format. The service application 118 further causes the user device 106 to present translated payment transaction message to the user 102 as one of the vibrotactile output, the audio output, or the visual output based on the operation mode in which the service application 118 is activated. The user 102 further enters the first authentication information, in Morse code format, to the user device 106 by way of the activated service application 118. For example, the service application 118 may present an interactive user interface on the display screen 812 for receiving the first authentication information (as shown in FIG. 5). The user 102 may interact with the interactive user interface by tapping the display screen 812 and the first authentication information entered by the user 102 is recorded.

At step 1116, the issuer server 114 receives the first authentication information from the user device 106 for authenticating the user 102. The first authentication information received from the user device 106 is in a message format compatible and associated with the issuer server 114. At step 1118, the issuer server 114 determines whether the user 102 is successfully authenticated based on the first authentication information. If at step 1118, the issuer server 114 determines that the user 102 is successfully authenticated, step 1120 is executed. At step 1120, the issuer server 114 further processes the payment transaction. At step 1122, the issuer server 114 communicates the transaction response indicating the result of the processing of the payment transaction to the user device 106 and the payment terminal device 108. When the transaction response is communicated to the user device 106, the service application 118 causes the user device 106 to translate the transaction response to Morse code format and present to the user 102 as one of the vibrotactile output, the audio output, or the visual output based on the operation mode in which the service application 118 is activated.

If at step 1118, the issuer server 114 determines that the authentication of the user 102 has failed, step 1124 is executed. At step 1124, the issuer server 114 declines the payment transaction and executes step 1122. If at step 1104, the issuer server 114 determines that the transaction card 104 is not issued to a differently-abled user, step 1120 is executed, where the payment transaction is processed as a regular payment transaction.

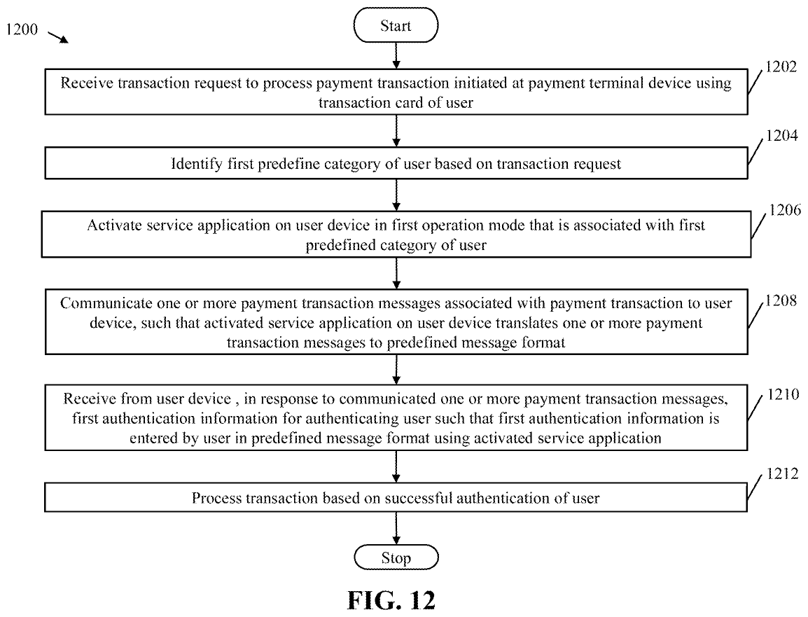

FIG. 12 is a high-level flow chart 1200 that illustrates a method for facilitating a payment transaction, in accordance with an exemplary embodiment of the present disclosure. At step 1202, a server (e.g., the payment network server 112 or the issuer server 114) receives a transaction request to process a payment transaction initiated at the payment terminal device 108 using the transaction card 104 of the user 102. At step 1204, the server (e.g., the payment network server 112 or the issuer server 114) identifies the first predefined category of the user 102 based on the transaction request. For example, the first predefined category is the first differently-abled category to which the user 102 belongs. At step 1206, the server (e.g., the payment network server 112 or the issuer server 114) activates the service application 118 on the user device 106 of the user 102 in the first operation mode that is associated with the first predefined category of the user 102. At step 1208, the server (e.g., the payment network server 112 or the issuer server 114) communicates one or more payment transaction messages associated with the payment transaction, to the service application 118 activated on the user device 106. The service application 118 activated in the first operation mode translates the one or more payment transaction messages to the predefined message format (i.e., the Morse code format). At step 1210, the server (e.g., the payment network server 112 or the issuer server 114) receives, from the user device 106, in response to the communicated one or more payment transaction messages, the first authentication information for authenticating the user 102. The first authentication information is entered by the user 102 in the predefined message format (e.g., Morse code format) using the activated service application 118. At step 1212, the server (e.g., the payment network server 112 or the issuer server 114) processes the payment transaction based on successful authentication of the user 102. The user 102 is authenticated based on the first authentication information.

Technical improvements in the issuer server 114 have eliminated the requirement for differently-abled users to rely on terminal devices for receiving transaction related messages and inputting authentication information for authentication purposes. The issuer server 114 is capable of hosting the service application 118 that has various operation modes compatible with various predefined categories (e.g., the plurality of differently-abled categories). Thus, technical improvements in the issuer server 114 enables presentation of transaction related messages to differently-abled users on their user devices in a message format (Morse code format) that is recognized and understood by the differently-abled users. For example, the issuer server 114 upon identifying the differently-abled category of the user 102, activates the service application 118 in the first operation mode that is compatible with the differently-abled category of the user 102. Due to the selection of the compatible operation mode of the service application 118, a specific output mechanism (e.g., the vibration generator 810, the audio generator 808, or the display screen 812) of the user device 106 is selected to output the transaction related message (in Morse code format) as a sense that the user 102 is capable of perceiving. For example, if the user 102 is deaf and blind, the transaction message is outputted in Morse code through a vibrotactile output that can be perceived by the user 102 just by touching the user device 106. Further, the transaction cards issued to differently-abled users have no transaction card details printed or embossed thereon. Thus, transaction frauds due to compromised transaction card details are reduced. Assigning specific BINs to various differently-abled categories helps the issuer server 114 in identifying transactions corresponding to differently-abled users in an efficient manner. Further, technical improvements in the issuer server 114 enables extension of time-out periods of terminal devices for the transactions corresponding to the differently-abled users, thereby increasing the convenience of differently-abled users to carry-out transactions.

Techniques consistent with the present disclosure provide, among other features, systems and methods for facilitating transactions for differently-abled users. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A method for communicating with a remotely activated service application, the method comprising:
receiving, by a server, a transaction request to process a payment transaction initiated at a payment terminal device using a transaction card of a user;
identifying, by the server, a first predefined category of the user based on the transaction request;
activating, by the server, the service application on a user device of the user, wherein the service application is remotely activated in a first operation mode associated with the first predefined category of the user;
communicating, by the server, one or more payment transaction messages associated with the payment transaction, to the service application activated on the user device, wherein the service application activated in the first operation mode translates the one or more payment transaction messages to a predefined message format;
receiving, by the server, from the service application activated on the user device, first authentication information for authenticating the user in response to the communicated one or more payment transaction messages, wherein the first authentication information is entered by the user in the predefined message format by way of the service application activated in the first operation mode; and
processing, by the server, the initiated payment transaction upon successful authentication of the user, wherein the user is authenticated based on the first authentication information.

2. The method of claim 1, wherein the first predefined category of the user is identified based on a first identification number of the transaction card, and wherein the transaction request is indicative of the first identification number.

3. The method of claim 2, further comprising assigning, by the server, one or more identification numbers uniquely to each of a plurality of predefined categories for managing transaction card issuance to a plurality of users belonging to the plurality of predefined categories, wherein the transaction card, issued to the user belonging to the first predefined category, is associated with the first identification number assigned to the first predefined category.

4. The method of claim 3, further comprising storing, by the server, in a database associated with the server, the one or more identification numbers that are uniquely assigned to each of the plurality of predefined categories, wherein the first predefined category of the user is identified by referring the database based on the transaction request.

5. The method of claim 1, further comprising:
determining, by the server, a first time-duration for extending a time-out period for the payment transaction, based on the identification of the first predefined category of the user; and
communicating, by the server, to the payment terminal device, a time-out extension message indicating the first time-duration, wherein, based on the time-out extension message, the time-out period for the payment transaction is extended to the first time-duration by the payment terminal device.

6. The method of claim 1, further comprising:
receiving, by the server, from the service application activated on the user device, upon issuance of the transaction card to the user and prior to receiving the transaction request, reference authentication information that is to be linked to the transaction card, wherein the reference authentication information is entered by the user in the predefined message format by way of the service application operating in the first operation mode on the user device; and
linking, by the server, the received reference authentication information to the transaction card, wherein the user is successfully authenticated for the payment transaction based on a match between the first authentication information and the reference authentication information.

7. The method of claim 6, wherein the first authentication information and the reference authentication information received by the server are in a first message format associated with the server and different from the predefined message format, and wherein the first authentication information and the reference authentication information are translated from the predefined message format to the first message format by way of the service application, prior to communicating to the server.

8. The method of claim 1, further comprising hosting, by the server, the service application that is operable in a plurality of operation modes such that each of the plurality of operation modes is associated with one of a plurality of predefined categories, wherein the plurality of operation modes include the first operation mode and the plurality of predefined categories include the first predefined category of the user.

9. The method of claim 1, wherein the predefined message format is Morse code format and wherein the first operation mode is one of a visual mode, an audio mode, or a vibration mode.

10. The method of claim 1, wherein the first predefined category is a differently-abled category and one of a deaf-blind category, a mute-blind category, or a deaf-mute category.

11. A system for communicating with a remotely activated service application, the system comprising:
a server configured to:
receive a transaction request to process a payment transaction initiated at a payment terminal device using a transaction card of a user;
identify a first predefined category of the user based on the transaction request;
activate the service application on a user device of the user, wherein the service application is remotely activated in a first operation mode associated with the first predefined category of the user;
communicate one or more payment transaction messages associated with the payment transaction, to the service application activated on the user device, wherein the service application activated in the first operation mode translates the one or more payment transaction messages to a predefined message format;
receive, from the service application activated on the user device, first authentication information for authenticating the user in response to the communicated one or more payment transaction messages, wherein the first authentication information is entered by the user in the predefined message format by way of the service application activated in the first operation mode; and
process the initiated payment transaction based on successful authentication of the user, wherein the user is authenticated based on the first authentication information.

12. The system of claim 11, wherein the first predefined category of the user is identified based on a first identification number of the transaction card, wherein the transaction request is indicative of the first identification number, and wherein the first predefined category is a differently-abled category and one of a deaf-blind category, a mute-blind category, or a deaf-mute category.

13. The system of claim 12, wherein the server is further configured to assign one or more identification numbers uniquely to each of a plurality of predefined categories for managing transaction card issuance to a plurality of users belonging to the plurality of predefined categories, and wherein the transaction card, issued to the user belonging to the first predefined category, is associated with the first identification number assigned to the first predefined category.

14. The system of claim 13, wherein the server is further configured to store the one or more identification numbers that are uniquely assigned to each of the plurality of predefined categories in a database, and wherein the server identifies the first predefined category of the user by referring the database based on the transaction request.

15. The system of claim 11, wherein the server is further configured to:
determine a first time-duration for extending a time-out period for the payment transaction, based on the identification of the first predefined category of the user; and
communicate, to the payment terminal device, a time-out extension message indicating the first time-duration, wherein, based on the time-out extension message, the time-out period for the payment transaction is extended to the first time-duration by the payment terminal device.

16. The system of claim 11, wherein the server is further configured to:
receive, from the service application activated on the user device, upon issuance of the transaction card to the user and prior to reception of the transaction request, reference authentication information that is to be linked to the transaction card, wherein the reference authentication information is entered by the user in the predefined message format by way of the service application operating in the first operation mode on the user device; and
link the received reference authentication information to the transaction card, wherein the user is successfully authenticated for the payment transaction based on a match between the first authentication information and the reference authentication information.

17. The system of claim 16, wherein the server receives the first authentication information and the reference authentication information in a first message format associated with the server and different from the predefined message format, and wherein the first authentication information and the reference authentication information are translated from the predefined message format to the first message format by way of the service application, prior to communication to the server.

18. The system of claim 11, wherein the server is further configured to host the service application that is operable in a plurality of operation modes such that each of the plurality of operation modes is associated with one of a plurality of predefined categories, and wherein the plurality of operation modes include the first operation mode and the plurality of predefined categories include the first predefined category of the user.

19. The system of claim 11, wherein the predefined message format is Morse code format and wherein the first operation mode is one of a visual mode, an audio mode, or a vibration mode.

20. One or more computer storage media having computer-executable instructions for communicating with a remotely activated service application that, upon execution by a processor, cause the processor to at least:
receive, by a server, a transaction request to process a payment transaction initiated at a payment terminal device using a transaction card of a user;
identify, by the server, a first predefined category of the user based on the transaction request;
activate, by the server, the service application on a user device of the user, wherein the service application is remotely activated in a first operation mode associated with the first predefined category of the user;
communicate, by the server, one or more payment transaction messages associated with the payment transaction, to the service application activated on the user device, wherein the service application activated in the first operation mode translates the one or more payment transaction messages to a predefined message format;
receive, by the server, from the service application activated on the user device, first authentication information for authenticating the user in response to the communicated one or more payment transaction messages, wherein the first authentication information is entered by the user in the predefined message format by way of the service application activated in the first operation mode; and
process, by the server, the initiated payment transaction based on successful authentication of the user, wherein the user is authenticated based on the first authentication information.
